(19) United States
(12) Patent Application Publication
(10) Pub. No.: US 2007/0265927 A1
(43) Pub. Date: Nov. 15, 2007

(54) SOFTWARE DESIGN SYSTEM

(75) Inventor: Steven Lawrence Salter, Sterling Heights, MI (US)

Correspondence Address: DOBRUSIN & THENNISCH PC, 29 W LAWRENCE ST, SUITE 210, PONTIAC, MI, 48342, US

(73) Assignee: Temo, Inc.

(21) Appl. No.: 11/383,035

(22) Filed: May 12, 2006

(51) Int. Cl. G06Q 30/00; G07F 7/00; G06F 17/00

(52) U.S. Cl. 705/26; 715/505; 715/507; 705/27

(57) ABSTRACT

The present invention improves on the existing infrastructure for providing a consumer design system for building structures by providing a system, method and software configured for providing a user the ability to enter information relating the user and/or customer, surrounding conditions to the building site of the building structure, and building structural and aesthetic features based upon the surrounding conditions to the building structures. The present invention is particularly suited for forming building additions, such as sunrooms, conservatories or otherwise.

### FIELD OF THE INVENTION

The present invention is predicated upon a system, method and software for creating a custom design for a building structure and more particularly, additions thereto, based upon existing building structure and design choices.

### BACKGROUND OF THE INVENTION

Computer design systems, particularly software applications, are currently provided to consumers (such as home owners) for creating customized building structures, home or building improvements, or otherwise (e.g., basic house designs, decks, gardens, landscaping, or otherwise). Such programs are often provided for sale at local computer stores. These programs offer a limited ability to design the aforementioned structures as they are often oriented towards design aspect of the building or otherwise, without regards to foundations, utilities or cost. Further, these programs are typically intended for use by a home owner and not intended to form a customized building order for a particular builder. Accordingly, these programs fail to provide an order sufficient to enable a builder to obtain necessary building material and information to construct the same. Furthermore, these programs fail to take into consideration surrounding environmental conditions typically encountered by a builder. Such conditions may include air conditioning units, water spigots, windows, utility meters, existing structures or foundations, or otherwise. Still further, these programs fail to take into consideration the resulting cost of the project, particularly the material and labor costs.

In another aspect, some customized design companies offer design capabilities for some structures such as decks, gazebos, landscaping and otherwise. Examples of these companies include Home Depot™, Builder Square™, Lowes™, architects or design companies, and some builders. These companies often provide a technical assistant at the place of business, such as through an employee, for assisting the consumer in selecting and designing a customized structure. Upon completion, the user may be given a design to either purchases the material to build the design or otherwise hire a company to build the structure. However, these companies fail to take into consideration many design aspects such as the surrounding environmental and structural conditions to the proposed building site. Also, the companies fail to take into consideration, nor offer, the ability to allow the customer to perform some or all of the work for completing the structure. Furthermore, these companies fail to provide a completed order including a detailed analysis of all aspects of the construction, including cost, required material, work to be performed and resulting contract therefore.

In yet another aspect, contractors and builders are often requested to provide building quotes for the creation or modification of a building structure. This requires the builder to take measurements of preexisting structures and note such measurements along with sketches to correlate the measurement with an existing structure or otherwise. Before, or after, the builder determines these measurements the customer is afforded various design options to be constructed. Based upon the design selection and measurements, the builder must formulate a design for presentation to the customer. Unfortunately, this process can take days, weeks or even months to formulate a design and price quote. This often leaves the customer waiting for the builder before they can come to a final determination on whether they would like to have the structure built or whether they can even afford such a design. Also, it fails to provide an easy method of modifying the design to suit the financial constraints of the customer.

In view of the forgoing, there is a need of an accurate and detailed design system for creating a customized building structure based upon design selections of the customer, in view of existing surrounding conditions and optionally elected work to be performed by the consumer. Also, there is a need to create such design at the presence of the building site and preferably while the customer is available to make design selections to created a customized design order. Furthermore, there is a need to allow the customer to modify any resulting design or order to best suit the financial situation of the customer, form a contract for creation of the structure, perform a debt analysis to insure affordability and value of the structure, apply for and obtain discounts, coupons, and/or referral discount, or other incentives. Still further, there is a need for a computer design system capable of the foregoing that is directed for the modification of an existing structural building, such as a home or office, for the formation of a building addition, sunroom, conservatory, the like or otherwise.

### SUMMARY OF THE INVENTION

The present invention improves on the existing infrastructure of customized building design systems, and methods thereof, by providing a custom design system for designing building structures, or improvements thereof which is orientated to the specific details of the surrounding environment or preexisting conditions, design considerations, and cost of the resulting structure. By doing so, the present invention provides a system, method and software configured for designing a customized building structure by providing a user the ability to enter information in data entry fields relating to the user or customer, surrounding conditions of the building site, and selected structural and aesthetic building features, which may be based upon the surrounding conditions to the building structure. Optionally, the present invention further includes a checking and/or validation feature to insure that all data entry fields are fully and properly entered to insure proper design and cost estimation of the building structure. Still further, the invention may also provide a customized order based upon the information inputted, and which may include a contract including the order, user information and builder information. Even further, without limitation, the invention may include the ability to tailor a customized design based upon the financial means of a customer, which may include amendments to the customized order, discounted cost, incentive, or otherwise.

In one aspect, the present invention provides a computer having a user interface for allowing a user to interact with a software program for creating and storing information relating to a customized building order. The software program provides: a first input field for inputting and storing information relating to a customer or job; a second input field for inputting and storing information relating to preexisting conditions surrounding a building site for the customized building; a third input field for selecting and storing information relating to the customized building addition which may be based upon the information inputted in the second data entry field; and an output comprising an order for the customized building addition which is based upon the information entered in the first, second and third data entry fields.

In another aspect, the present invention provides a method of formulating a customized building structure for a preexisting home. The method including the steps of: providing a computer having a user interface, the computer including software configured for providing data entry fields for entering information for forming a customized building structure for a preexisting home; inputting information in a first data entry field provided by the software, the first data entry field configured for receiving information related to a user or customer; inputting information in a second data entry field provided by the software, the second data entry field configured for receiving information related to preexisting conditions of a home to which the sunroom or conservatory is to be attached; inputting information in a third data entry field provided by the software, the third data entry field configured for receiving information related to selected components for the customized sunroom or conservatory; and generating a customized order for the sunroom or conservatory.

Other aspect of the present invention will be appreciated as described and shown herein.

### BRIEF DESCRIPTION OF THE DRAWINGS

FIG. 1 illustrates a schematic view of the overall design system of the present invention.

FIGS. 2a and 2b illustrates installation and interaction of a first and second software component of a software design system of the present invention.

FIGS. 3a and 3b illustrates operational flow of the software design system of the present invention used to formulate a customized design.

FIG. 4 illustrates a screen depiction of a first data entry field according to the teachings of the present invention.

FIGS. 5a through 5f illustrates various screen depictions of a second data entry field according to the teachings of the present invention.

FIGS. 6a through 6t illustrates various screen depictions of a third data entry field according to the teachings of the present invention.

FIGS. 7a through 7g illustrates various screen depiction of an order and processes and features thereof for a customized building structure based, at least in part, upon the information entered in the first, second and third data entry fields.

### DETAILED DESCRIPTION

The present invention provides a system, method and software for designing a customized structure, either stand alone or an addition to a preexisting structure, based upon the surrounding conditions of a building site and selection of components by the user or customer. In doing so, the system provides the ability of a customer or user to formulate a customized building structure and optionally an order therefor. This order may include the total cost estimation for construction of the structure and may be sufficient to enable a builder to create the customized structure based substantially on only the information provided by the user.

The customized order may include an allocation of work to be performed by the builder and/or the user of the system (e.g., customer, homeowner or otherwise). Accordingly, in one aspect, the system provides the ability to allow a homeowner to elect to perform some or all of the work during or prior to construction of the customized structure. In doing so, the system allows reduction of work to be performed by the builder in order to reduce the overall cost of the structure. This may include removal, modification, or addition of structures, or otherwise.

The system may be used or provided in numerous environments including home, business or otherwise. For example, it is contemplated that all or a portion of the system may be made available for purchase or is otherwise distributed to the public. The consumer is then afforded the opportunity to utilize the system to create a customized building structure order. Advantageously, this order may be based upon the building or labor cost of one or more available builders. In another example, the system may be provided at a place of business for providing a user (e.g. customer or otherwise), technical assistant, or both, the ability to create a customized building structure. In doing so, the customer, with the help of a technical assistant, can create a customized building project, which preferably includes an order for the same.

In view of the forgoing, it should be appreciated that the system of the present invention may be used for numerous applications. For example, the system may be used for designing stand alone structures including buildings such as offices, houses, gazebos, barns, workshops, garages, sheds or otherwise. Other structures may include carports, canopies, enclosures, or otherwise. Alternatively, it is contemplated that the system may be used to form a customized landscaping, gardening, or otherwise.

However, in one particularly advantageous application, the system of the present invention is used to alter an existing structure to increase size, aesthetic or otherwise improve some aspect of an existing structure. This application is particularly suited for the present invention because of the ability of the system to ascertain the preexisting structure and provide a design matrix based upon the constraints of the preexisting structure. Among these available applications, one particularly advantageous application includes the use of the system to design sunrooms, conservatories, and other building additions, for attachment to preexisting homes. In the formation of these structures, it is contemplated that the system is made available at the building site, wherein a technical assistant, such as an employee or sales representative, assists a customer in the formation of an order.

The system is used by a sale representative of a building and/or design company trained or otherwise skilled to interact with a customer to formulate the customized building design. In doing so, the representative goes to the customers intended building site with the system of the present invention, which may include a laptop computer or the like. The representative then enters information into the system pertaining to the surrounding conditions or existing structure to be modified. The customer then, through the representative, selects various features of the customized design, which may be based upon the previously entered information. Thereafter, the system provides a customized order, including cost estimation, for the building structure based upon the surrounding conditions and selected components by the customer. Preferably, in one configuration, the system is further configured to allow the user, through the sales representative, to amend the order, use referral coupons, or use other incentives to reduce the cost of the building design order.

However, it is contemplated that all or a portion of the system may be made available over a network, via the Internet or otherwise, wherein a representative can access all or a portion of the system (including a software program) over the network. In this configuration, it is contemplated that the representative accesses the network while at the customer's home, business or wherever the building site may be.

Alternatively, it is contemplated that the system may be located at the builder's place of business. In this configuration, the customer may bring information related to the building site to the place of business for entering into the design system.

As previously mentioned, the system is configured to receive information from a user to form the customized building design order. This information is preferably saved and incorporated into a job order and stored on a memory module of the computer, or otherwise, for later review, use, modification, or otherwise. More preferably, this information is used to progress through a matrix of design requirements or options. For example, through the progression of the system, it is contemplated that the system inquires to certain conditions surrounding the building site. Upon providing an indication to each of the inquiries, or data entry points, the system responds with additional inquiries relating to the same subject or proceeds to the next inquiry, which may be based upon the previous inquiry. The response to these inquiries may affect the availability of certain design choices and/or options. As such, the system is configured to only provide design options based upon availability in view of the surrounding environment and design indicated by previous design choice or selection. Additionally, the resulting order may call for the builder or the customer to perform certain tasks to the surrounding conditions in order for the building to be completed within the time constraint and/or estimated project cost.

In providing data entry points for entering information relating to a customized building order, the system includes one or more data entry fields for ascertaining information related to a customized building structure. In one configuration, the system includes a data entry fields for: i) entering customer or job information, ii) entering information relating to the preexisting conditions or structures, iii) and information relating to the selection of a customized building structure based upon the information entered relating to the preexisting structure. During entry of information into the data entry points, the system may validate the information for accuracy by comparing entered information to previously entered data to insure that the proposed design meets local codes or is other wise practical in view of other information. For example, the system may likely provide a warning message if adjacent walls portions are not or of a different height. The system may also require some or all of the information to be entered prior to movement between data entry fields.

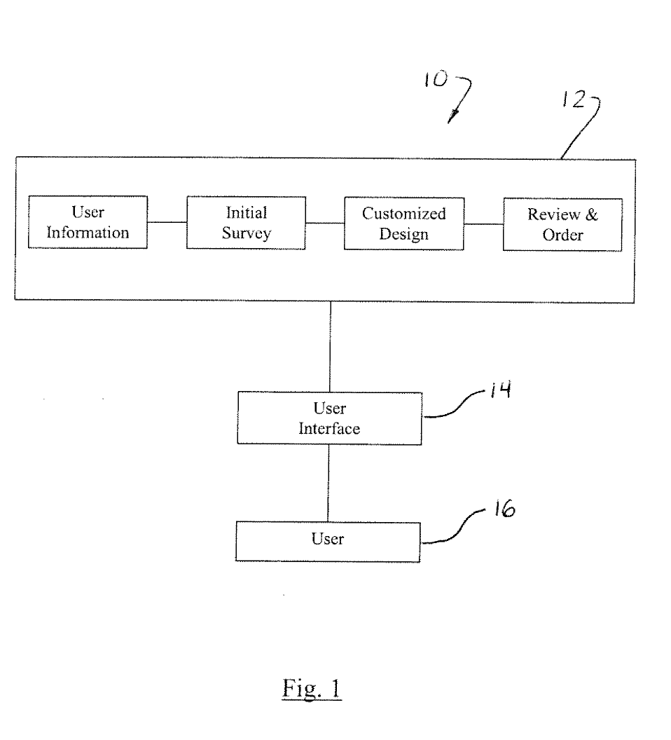

In one configuration, referring to FIG. 1, the design system 10 includes a computer (or the like) 12 having software and a user interface (e.g., screen, mouse, finger or touch pad, keyboard, or otherwise) 14 for allowing a user 16 to interact with the software. The software provides a progressive system for collecting information through the data entry points and fields. The software provides interactive icons for allowing a user to progress through the software, obtain help with the program, or terminate the program. Also, the software further includes tabs for moving through various areas (or data entry fields) of the program to further provide more control for the user. However, it is contemplated that the software may also provide restricted movement through the data entry points or fields to ensure complete input to inquiries provided by the software. This is particularly important so as to insure that a user is provided with only available options for the building and so that any final estimated cost given is generally accurate.

The user interface is in communications with the computer to interact with the software located thereon. As previously described, the user interface may be located proximate to the computer or remotely. In one example, the user interface comprises common features used for interacting with the software located on the computer. Accordingly, it is contemplated that the user interface may include features such as monitor, keyboards, mouse, combinations thereof, or otherwise, attached or incorporated with the computer for interacting with the software.

Alternatively, the user interface may be located remotely, via a network, and configured to communicate with the computer having the software. In this configuration, the user interface may comprise a work station, another computer, or otherwise, for communicating with the computer having the software. By doing so, the software may be located on a server and accessible via a wired or wireless network.

Installation/Operation of the Software Design System

Installation of the software onto the computer may be performed by a layperson with some experience with installation computer software. The software may be provided on a storage medium (such as a compact disc, media stick or otherwise) and subsequently installed onto one or more computers. Alternatively, some or all of the software, including software updates, may be provided via the Internet. Accordingly, a version of the software may be loaded onto a computer, through a compact disc, or otherwise, and subsequently updated through the Internet. In doing so, the user is insured of the most recent version of the software and in some applications the most resent design choices for forming the customized building structure are included in the software. Optionally, the software may be provided with encryption or password protected to insure valid receipts of the software.

The software of the system may be divided into separate components or instructions for installation onto computers. This may be particularly advantageous where the software is used by dealers of a particular product, which may have different needs or requirements, such as cost. In one example, it is contemplated that the system may include a first design software system and a second pricing software system. In this configuration, the software may be separately loaded onto the computer but configured to interact with each other. This allows for greater application of the software as the design software may be used to one or more builders or dealers, based upon a single supply or product line, but the pricing software may be unique depending on such factors as builder, location, labor or material cost, or otherwise. Also, this may allow the design software to be updated, via the internet, and the pricing software updated, via the specific dealer. However, the design and pricing software may be integrated into a single software package and updated separately,

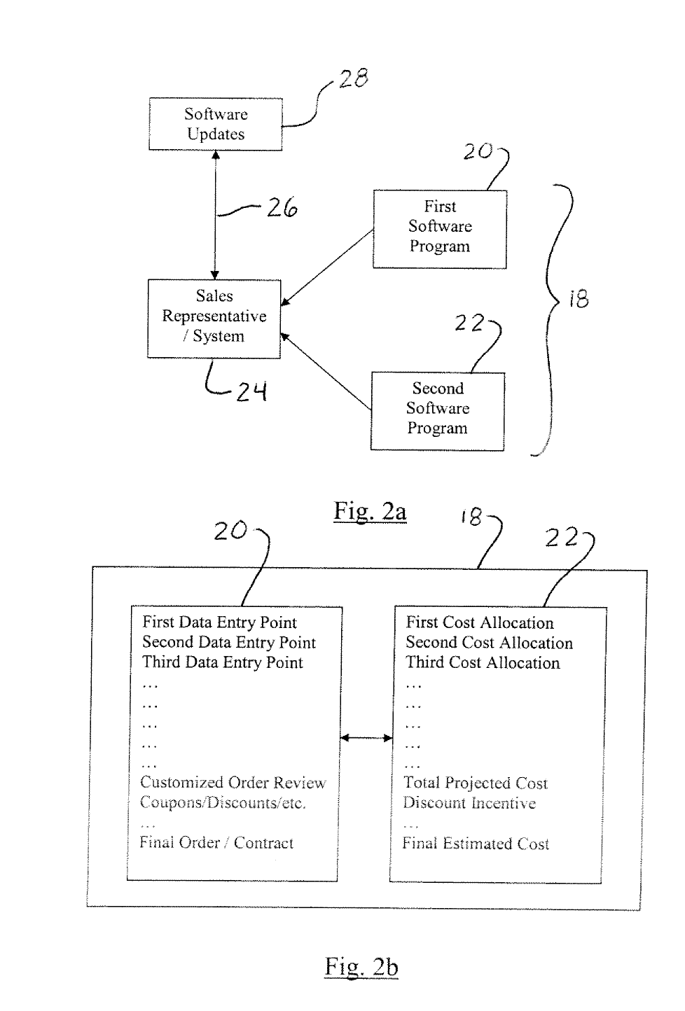

Referring to FIG. 2a, one configuration and example of installation of the software system 18 of the present invention is shown. In this configuration the software is divided into a first and second software program, instructions, file or database. The first software 20 comprises the design component of the software for providing responses to inquiries to formulate a customized building structure. The second software 22 comprises the pricing component of the software for providing pricing or cost for the selected or indicated components of the first software. While the following are discussed as two software programs, it should be appreciated that they are configured to operate in conjunction to provide a customized structure and cost estimate thereof. Also, in one embodiment, it is contemplated that they may be joined together into a single component or program.

In the configuration shown, the first software is installed onto a sales representative's portable computer (e.g. laptop, notebook or otherwise) 24. The software is then updated, via the internet 26, with a server 28 to update the database of available design options provided by the manufacture of the customized structure, or components thereof. In one configuration, the first software is provided or is otherwise based upon the manufacture of the customized structure. Accordingly, it is contemplated that the software updates may be provided on a manufactures server, which is accessible over the Internet.

The second software is then installed onto the representative's portable computer, which includes associated cost for the available components of the first software. Preferably, the pricing of the second software is determined by the builder or installer of the customized structure as opposed to the manufacture or supplier of the same. Accordingly, it is contemplated that the second software may be provided to the builder and more specifically the owner or operator thereof for creating the pricing policy.

Optionally, the second software loaded on the portable computer may be encrypted or otherwise password protected to prevent tampering therewith. Also, it is contemplated that while the first software may be made readily available for installation onto the portable computer, the second software may be protected or otherwise kept in a secured location available to owners and operators of the builder.

As with the first software, it is contemplated that the second software may be updated periodically. Accordingly, the owners, operators or otherwise that keeps the second software may also provide pricing/cost updates.

Referring to FIG. 2b, a simplified example of the relationship between the first and second software is shown. In this example, it is contemplated that in response to each inquiry (or group of inquiries when related to a single component of the order) responded to by the user, a correlating cost may be assigned and added to a total projected cost, which may be provided in an order review section of the first software. Upon completion of the design, and based upon responses by the user, the second software may include incentive for ordering the customized structure, as discussed herein, including discounts, coupons, referral bonuses, or otherwise. Upon completion, a final estimated cost is provided and displayed via the first software component. It should be appreciated that as with the pricing and cost information, the amount and structure of the incentives provided by the first and second software components may also be dictated by the owner or operator of the building company.

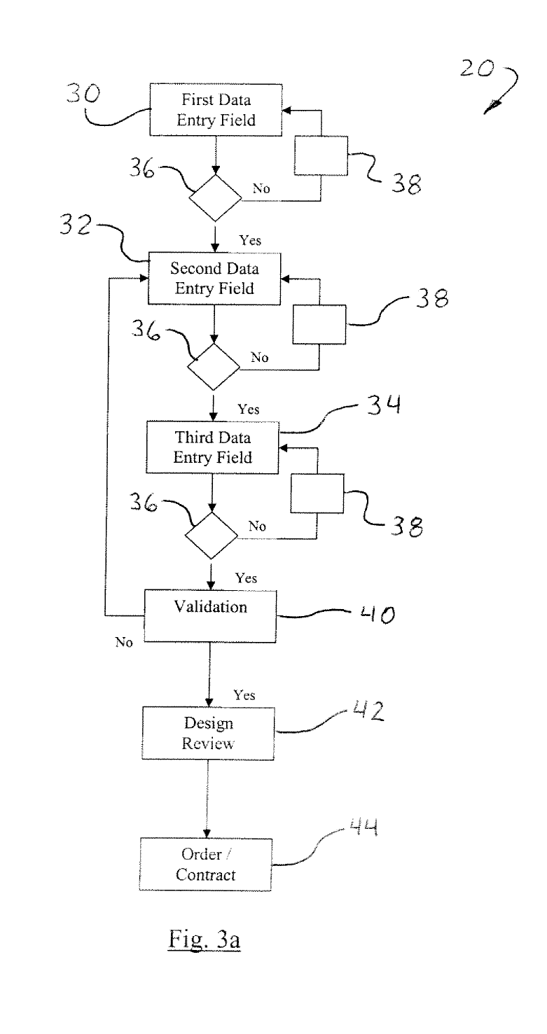

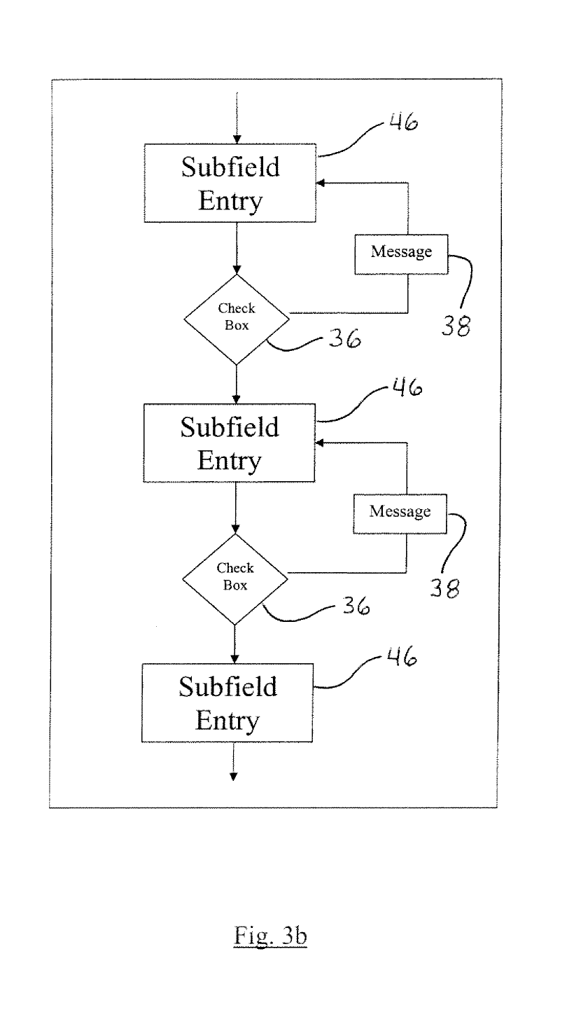

Referring to FIGS. 3a and 3b, examples of the operation of the design component (e.g. first software) of the software design system of the present invention are shown. With specific reference to FIG. 3a, an overall operational flow diagram of the design component is shown. The diagram shows several data entry fields (e.g. User Information, Initial Survey and Customized Design) which provide a design matrix for formulating the customized design. More specifically, the diagram shows a first data entry field 30, second data entry field 32 and third data entry field 34. Located between the data entry fields is a check feature 36 (e.g. the check box) for insuring complete response to necessary inquiries for forming the customized design, which may provide a messaging feature 38 for indicating failure to fully respond. Upon completion of the messaging system the program resumes to the data entry field.

Upon completion of the data entry fields, optionally, the system further includes an additional validating feature 40. However, it should be appreciated that validating system may comprise a portion of the checking system or otherwise be continual throughout the program wherein a warning or message may be provided upon input of an inconsistent response or value, which may be similar to the messaging feature 38.

The software also provides a design review feature 42 for providing the user with a summary of the design. Upon acceptance of the design, the software may provide an order/contract feature 44 for engaging a builder to build the structure. Optionally, though not specifically shown, the user may leave the design review section and modify any of the first, second or third data entry fields. It should be appreciated, though not shown, that additional features may be included with this simplified depiction of the operational flow of the design component of the software design system, as described herein, including incentives or otherwise.

As described further herein, the data entry fields may be separated into subfields which may include inquiries directed to a specific design aspect, surrounding condition, or otherwise. For example, referring to FIG. 3b, an example of subfields 46 of any of the data entry fields is shown. It is contemplated that, as with the flow chart shown in FIG. 3a and specifically between the data entry fields, the specific data entry field may include a check feature 36 and messaging feature 38 located between the subfields.

The software of the system may be used with different operating systems of a computer system. Such operating systems include common operating system of Windows, MAC, or variants thereof. However, other operating systems may be used as well including Unix, Microsoft™ DOS, or otherwise. However, in one preferred configuration, the software is configured to operate on a Window platform including such operating platforms as Windows 98, Windows 2000, Windows ME, Windows NT, Windows XP, or new versions thereof.

Similarly, as discussed more herein, it is contemplated that the software of the system may utilize features of different computer programs commonly used with computers. Such programs may include one or more Microsoft programs such as Word, Excel, Outlook, Explorer, or otherwise, or non-Microsoft programs such as Adobe Acrobatic Reader, or otherwise. In doing so, the software may be configured to display information relating to selected customized design. In one application, the software program utilizes Microsoft Excel to display selected components and prices of the customized building structure.

The software is may be based upon programming languages compatible with the operating system of the computer. Accordingly, the software may be based upon programming languages such as ABAP, Ada, AWK, Assembly, C, C++, C#, COBOL, Common Lisp, ColdFusion, Delphi, Eiffel, Fortran, JADE, Java, JavaScript, Limbo, Lua, Objective-C, Pascal, Perl, PHP, Python, REALbasic, RPG, Ruby, SQL, Tcl, Visual Basic, VB.NET, Visual FoxPro, or otherwise.

However, in one preferred configuration, the software is designed and operates under the programming language of Visual Basic, such as Visual Basic 6.0. This program provides a simple to use graphical user interface (GUI) for providing various screen depictions. In doing so, program provides the user with the ability to enter requested information to formulate the customized building design. Furthermore, the program is responsive to the information provided by the user and configured for provided outputs based upon the user input. Upon completion of the formulated customized design, a file may be created for the customized job and stored on the computer hard drive or other memory storage device.

Program Controls

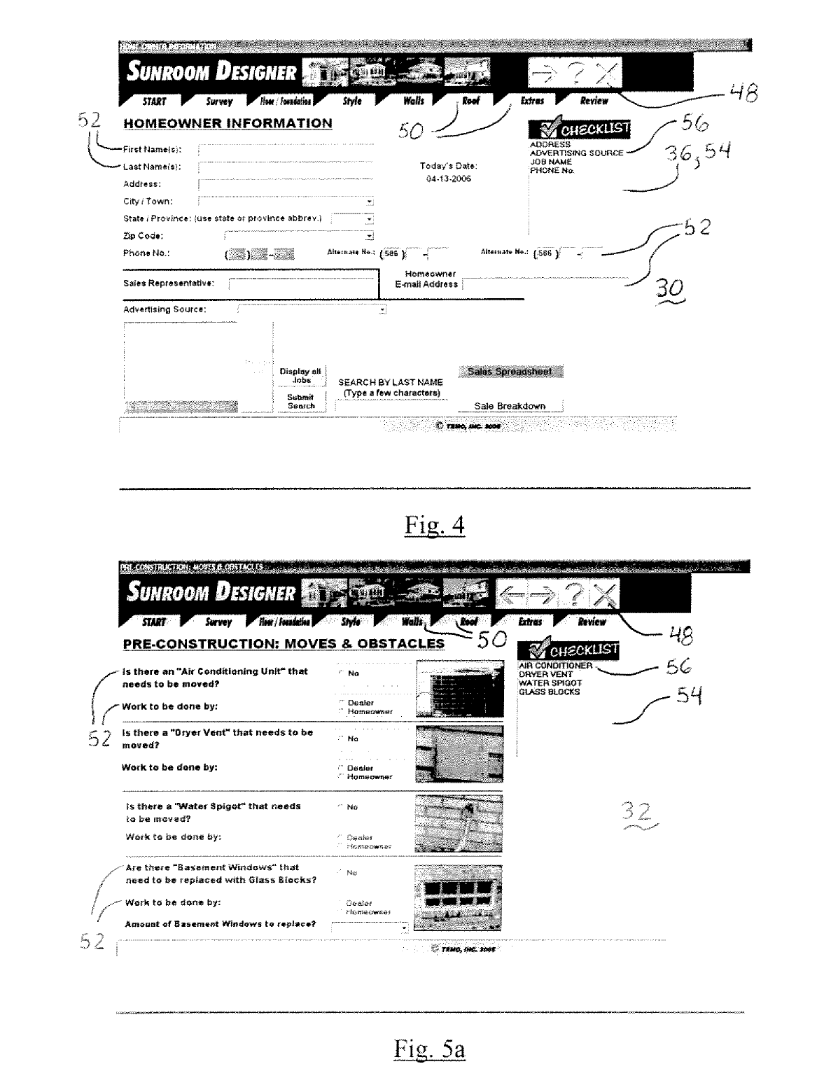

The software includes features, accessible through the user interface, for interacting and/or controlling the operation of the software. For example, referring to FIGS. 4-7h, a first feature may include a control bar 48 including scrolling feature which allows movement through the program, particularly between different data entry fields or subfields. The control bar may also include a termination button for closing or ending operation of the program and a save button for saving progress made with the program. Still further, it is contemplated that the control bar may also include a help icon for assisting a user through the program. The help icon is configured for providing information relating not only to the operation of the program but also to terms and definitions relating to the customized design.

In a second feature, the software provides an indication of the progression through the design program, such as the current data entry field or subfields thereof. Optionally, this progression indication also provides the ability to jump to different portions of the application for reviewing or editing previously entered information. As should be appreciated, it is contemplated that certain restriction may be used, e.g., through the checklist function as described further herein, to insure that the user does not prematurely advance to a portion of the program without entering in foundation data, such as information pertaining to the surrounding structure or otherwise.

In one configuration, the second feature comprises one or more tabs 50 for allowing the user to advance or retreat to previous portions of the program. Optionally, a tabs may be provided for each data entry section (e.g., i) entering customer or job information, ii) entering information relating to the preexisting structure or conditions, iii) and information relating to the selection of a customized building structure based upon the information entered relating to the preexisting structure, or otherwise).

Data Entry Fields

As previously mentioned, the software application may be equated to one or more data entry fields for formulating the customized design. Each data entry field may include subfields further segmenting the data entry fields into separate screen depictions or components. The data entry fields and subfields include one or more data entry points for inputting information relating to the customized building design. These data entry points may comprise the selection of a feature (e.g., check box or the like), numeric or text input (through typing or selection of provided numeric value or text), or otherwise.

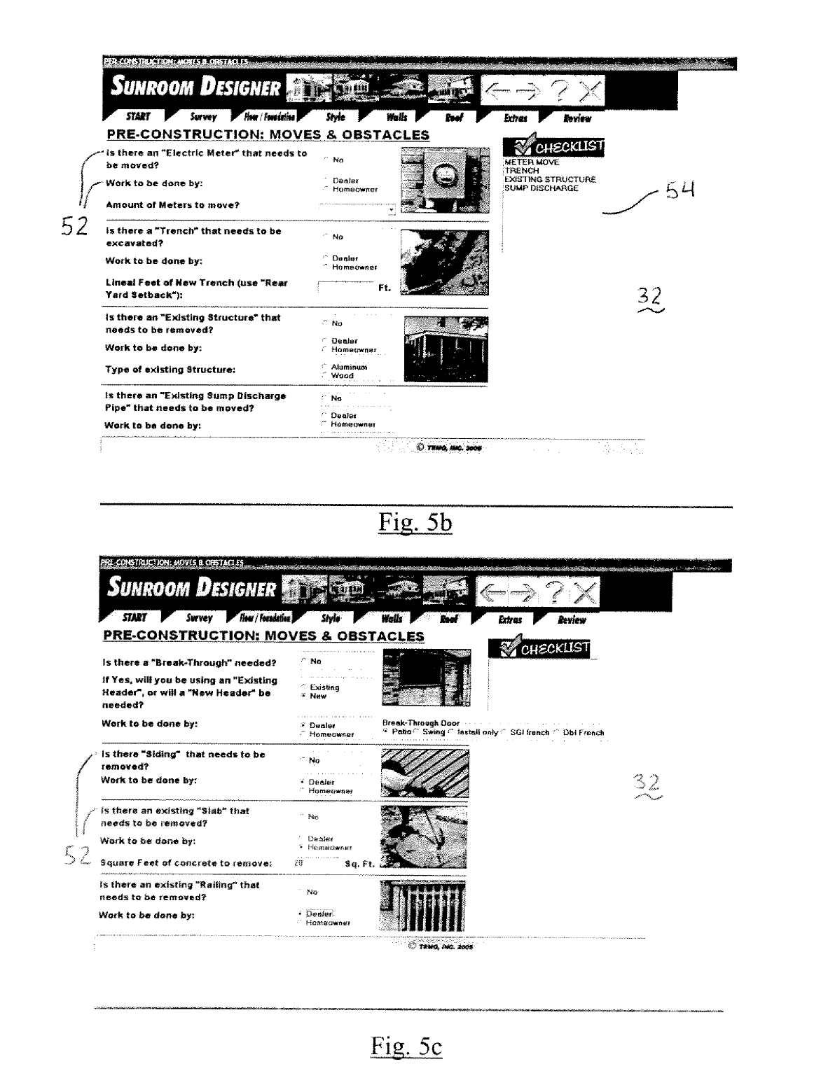

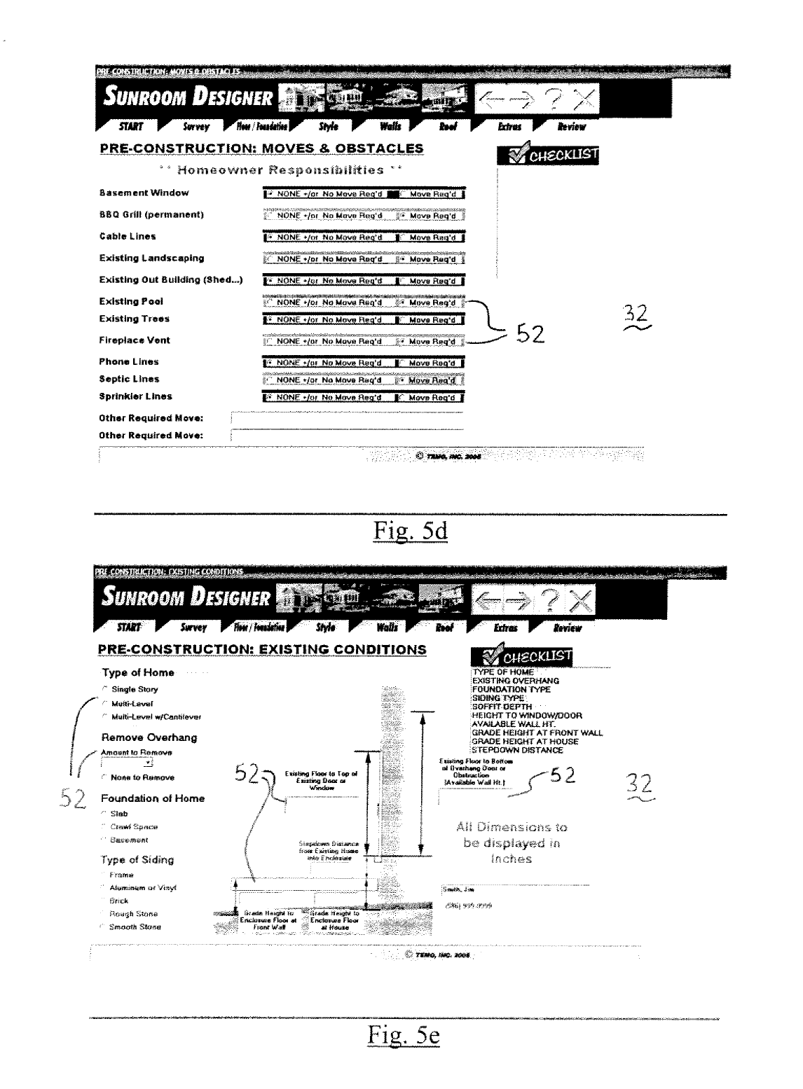

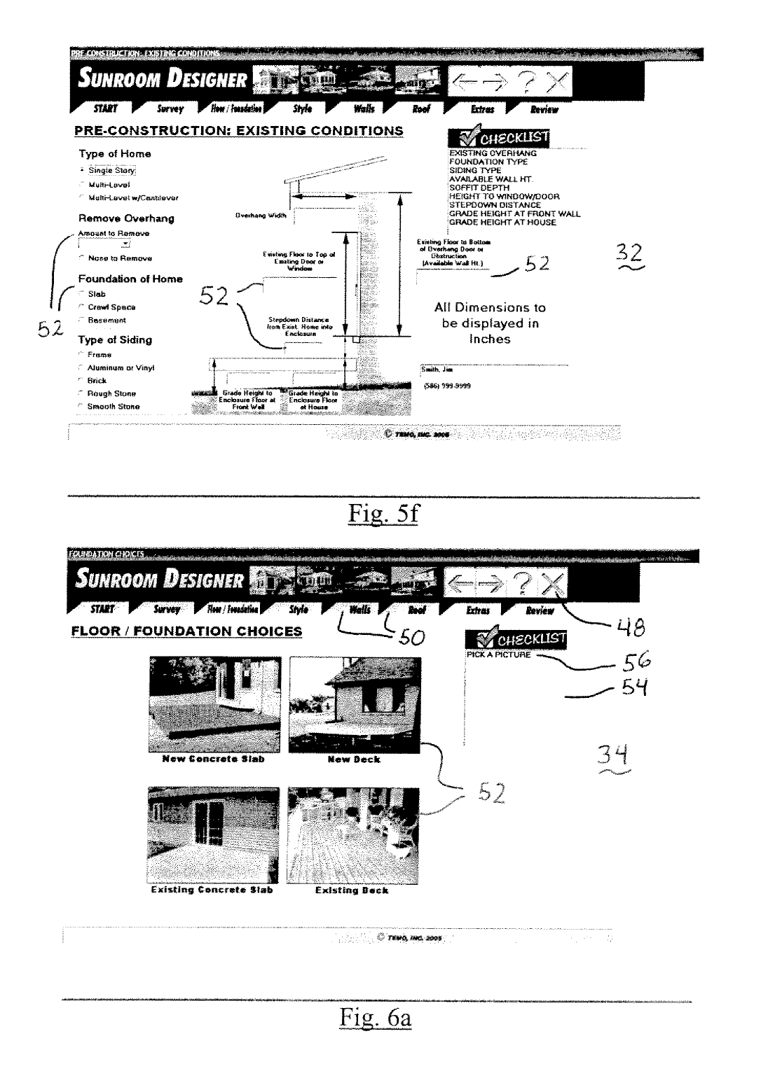

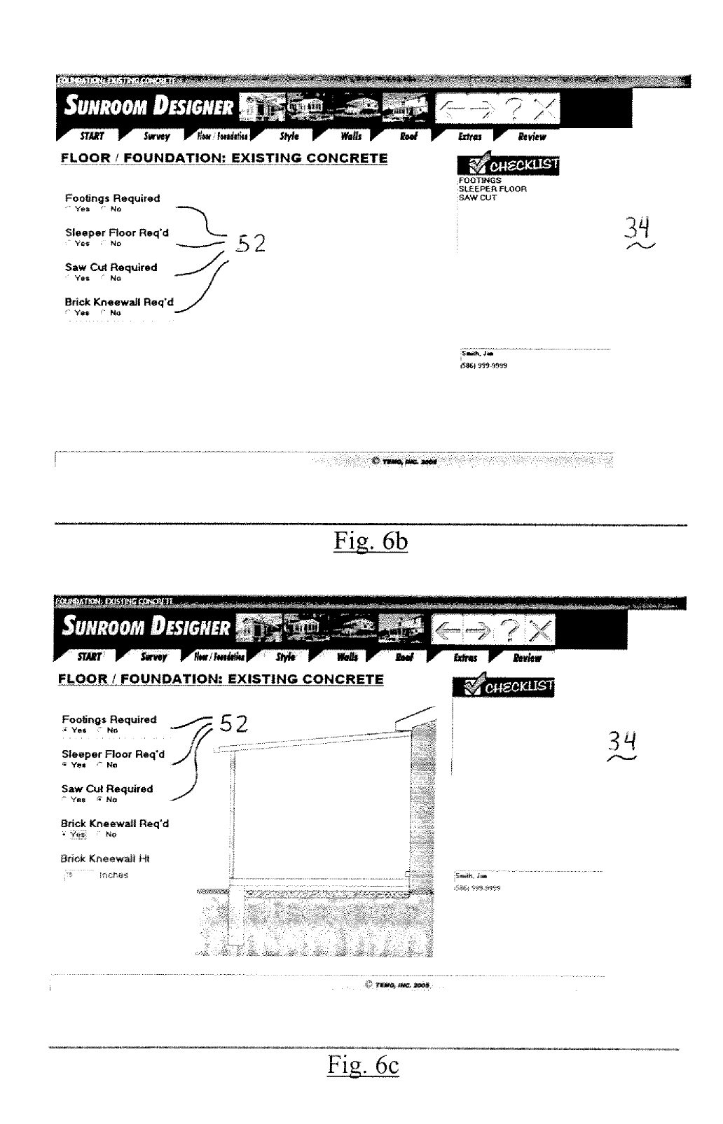

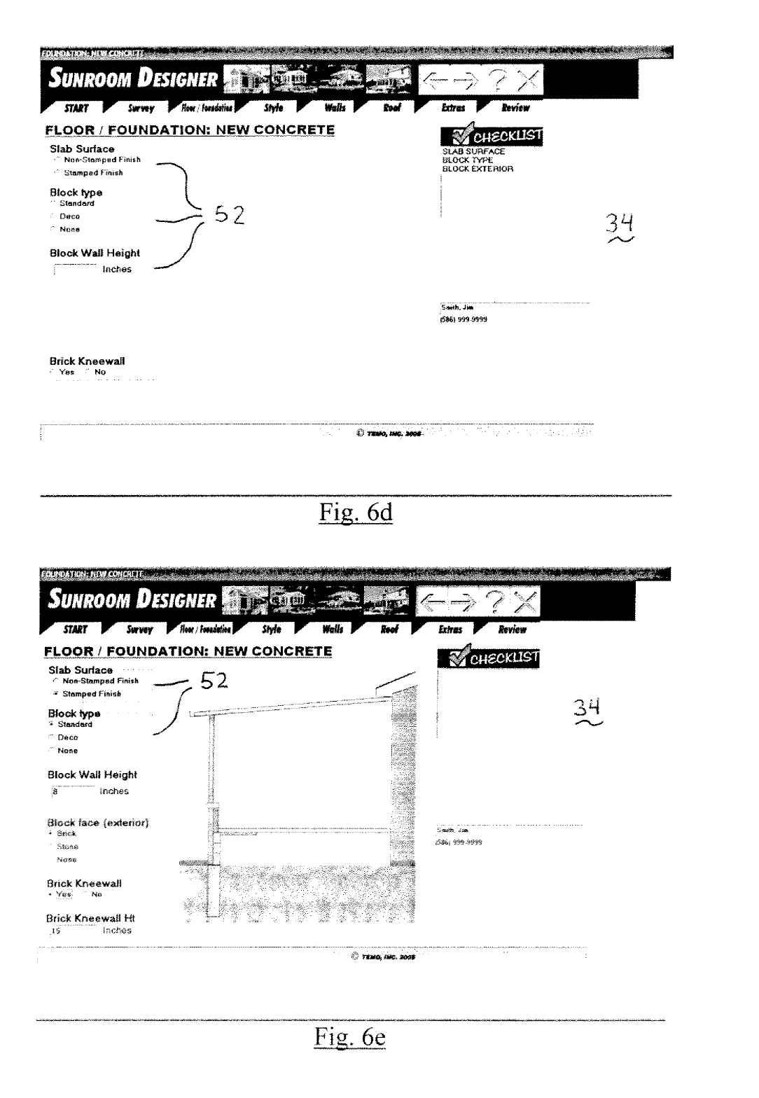

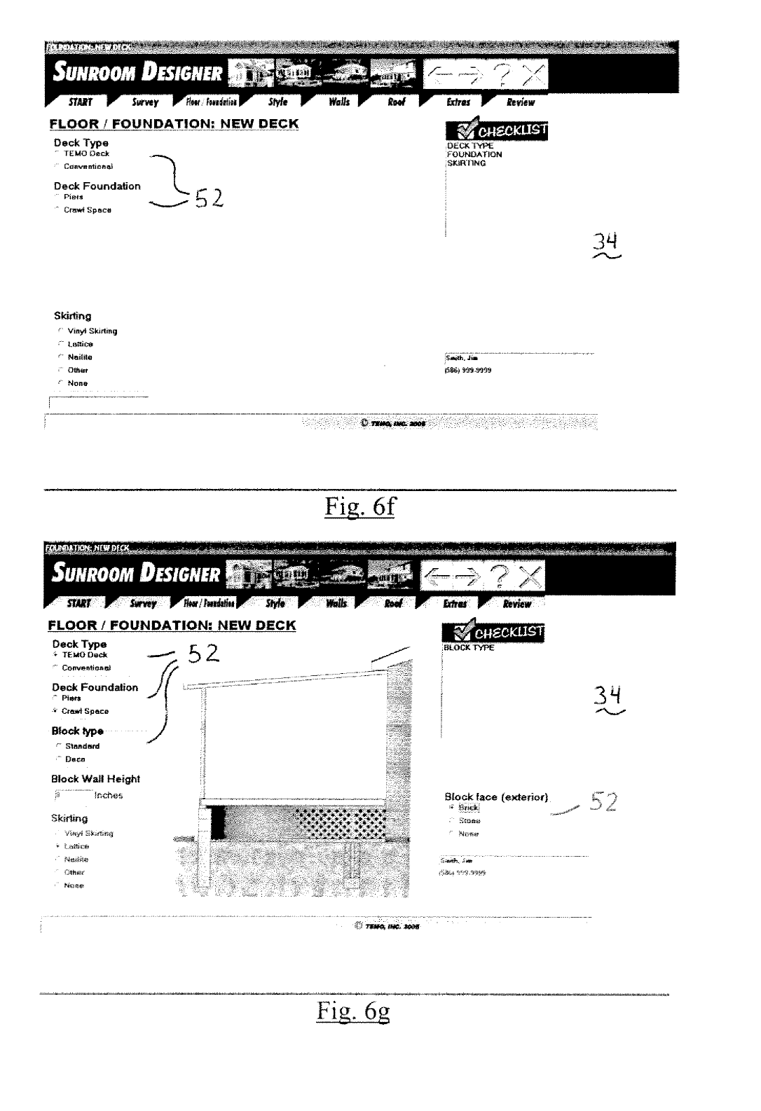

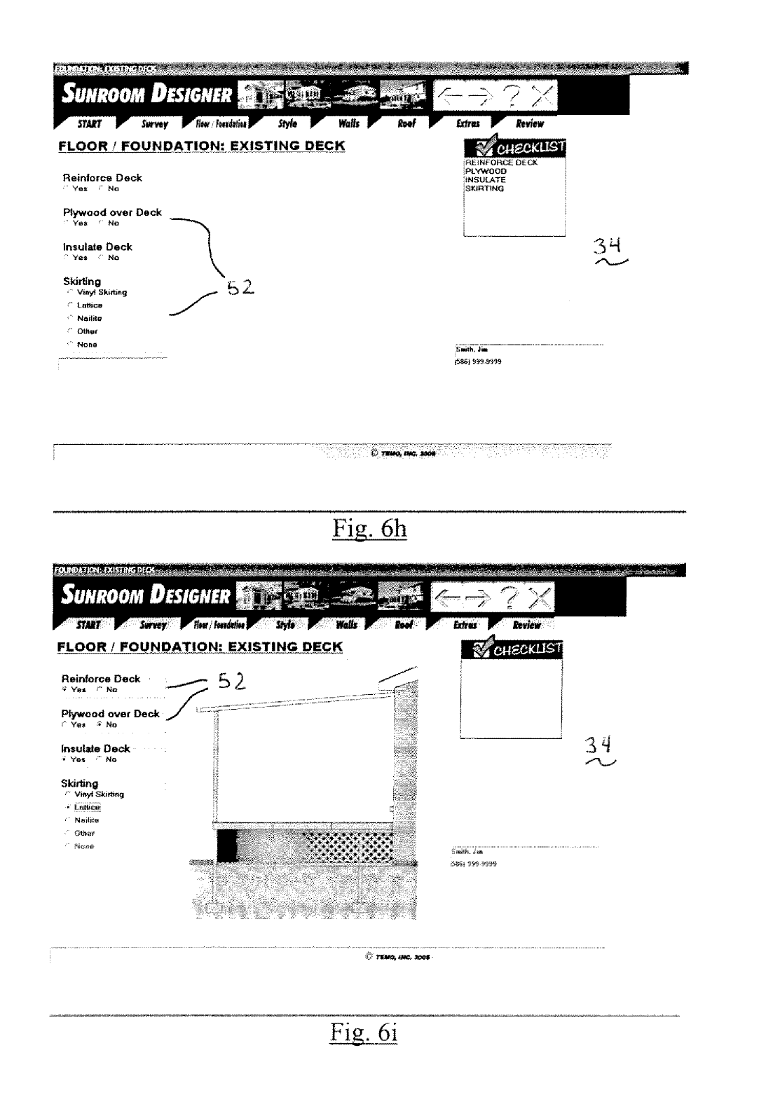

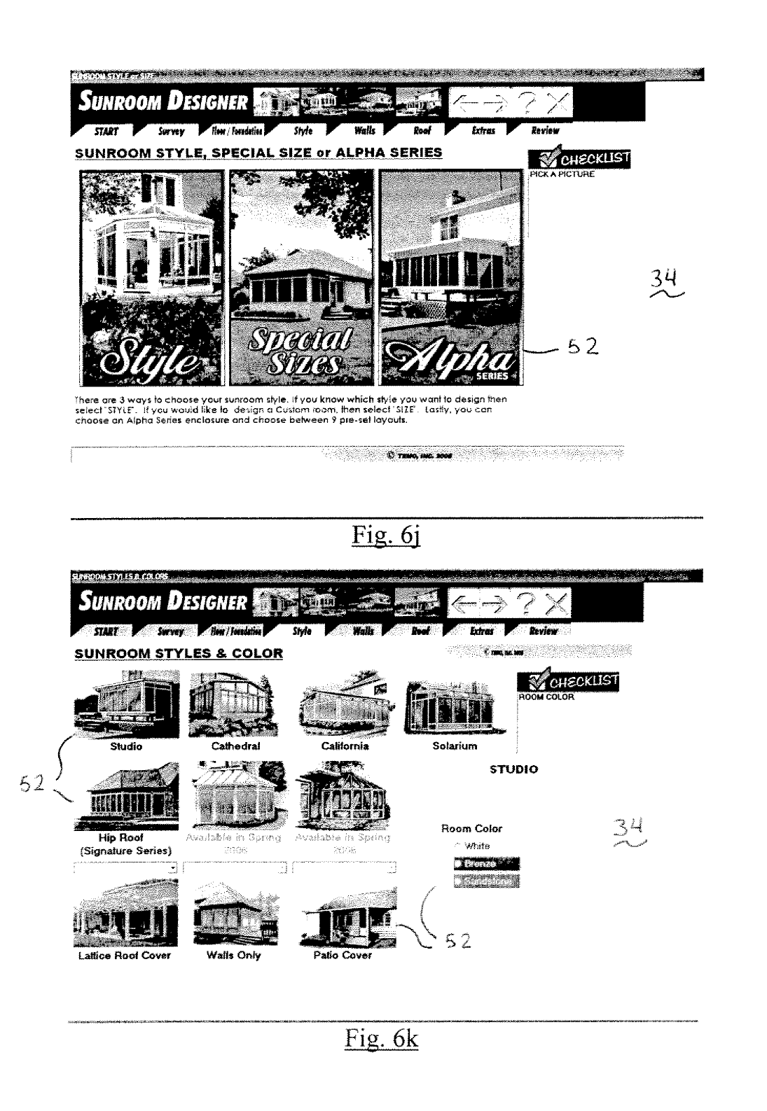

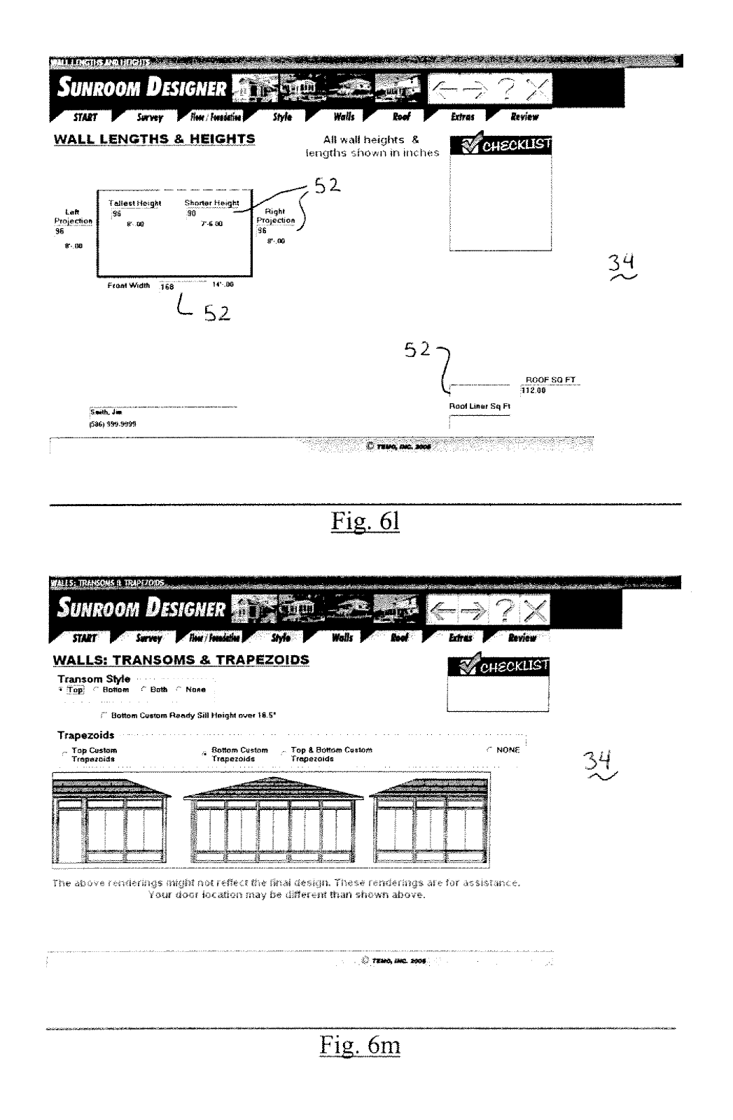

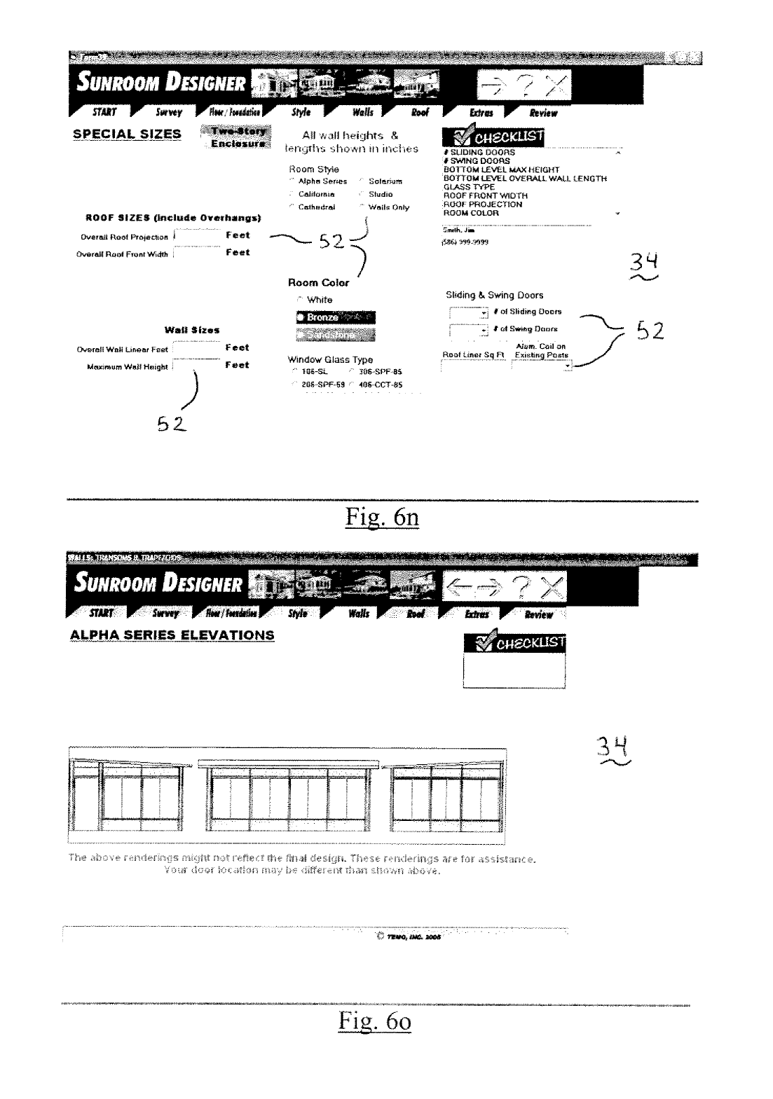

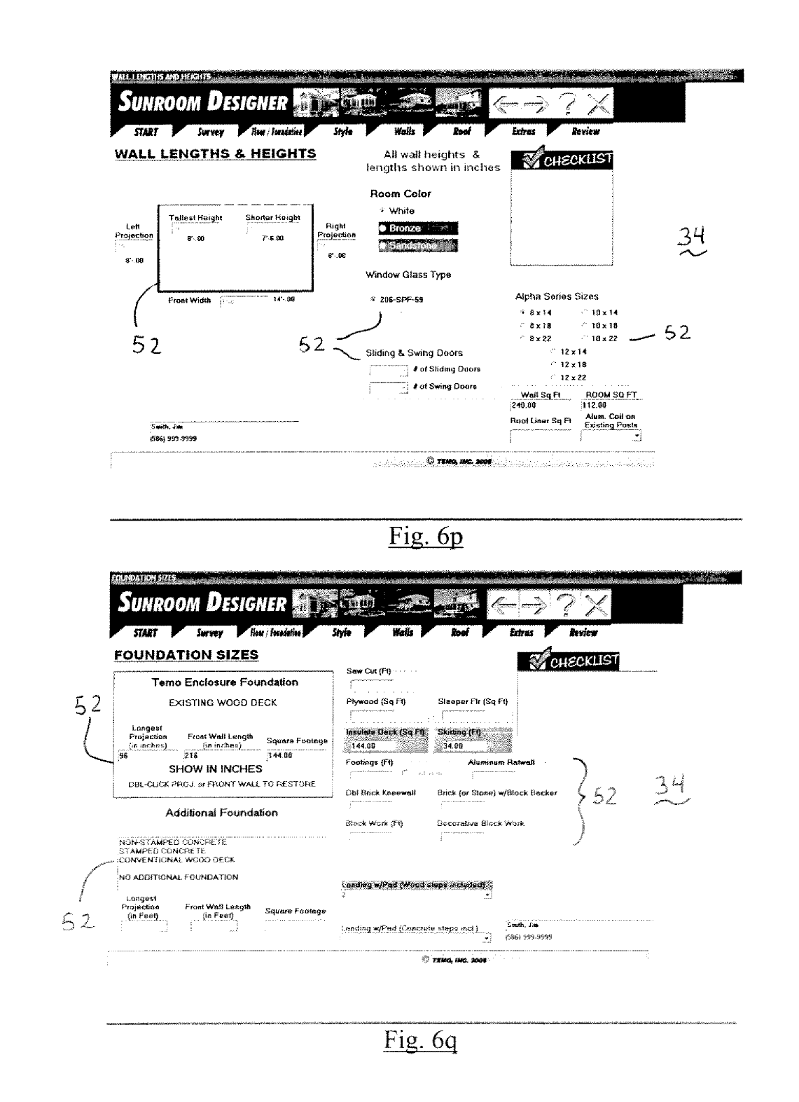

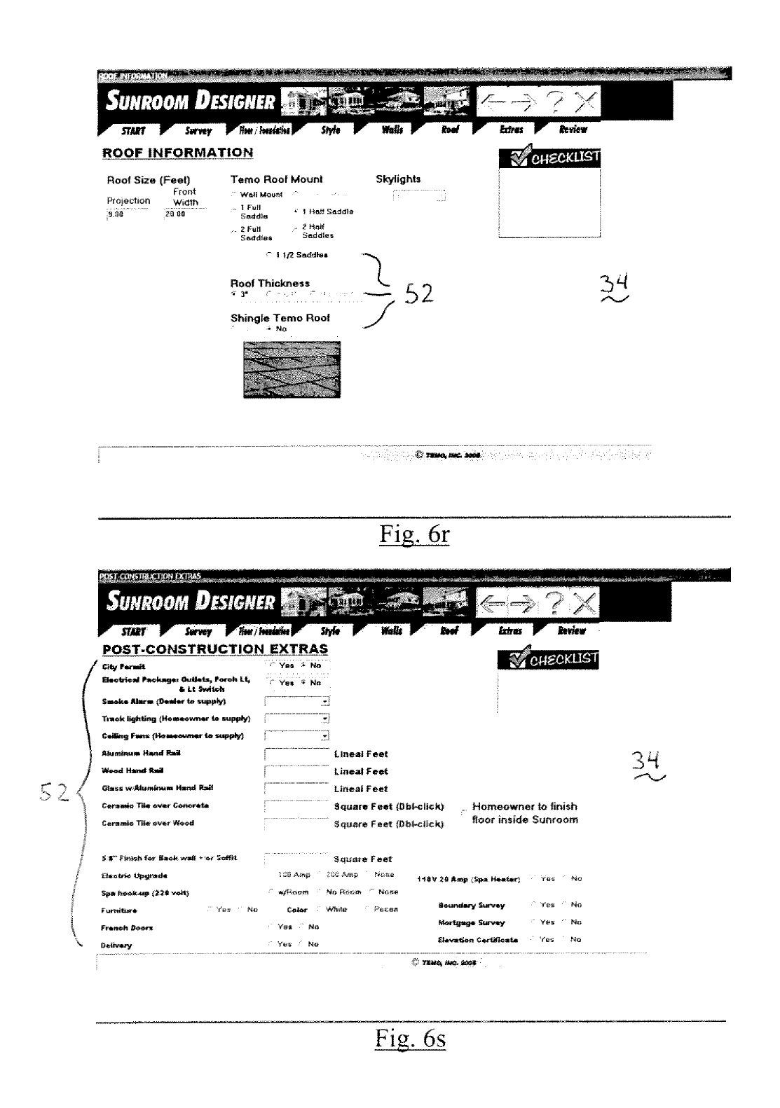

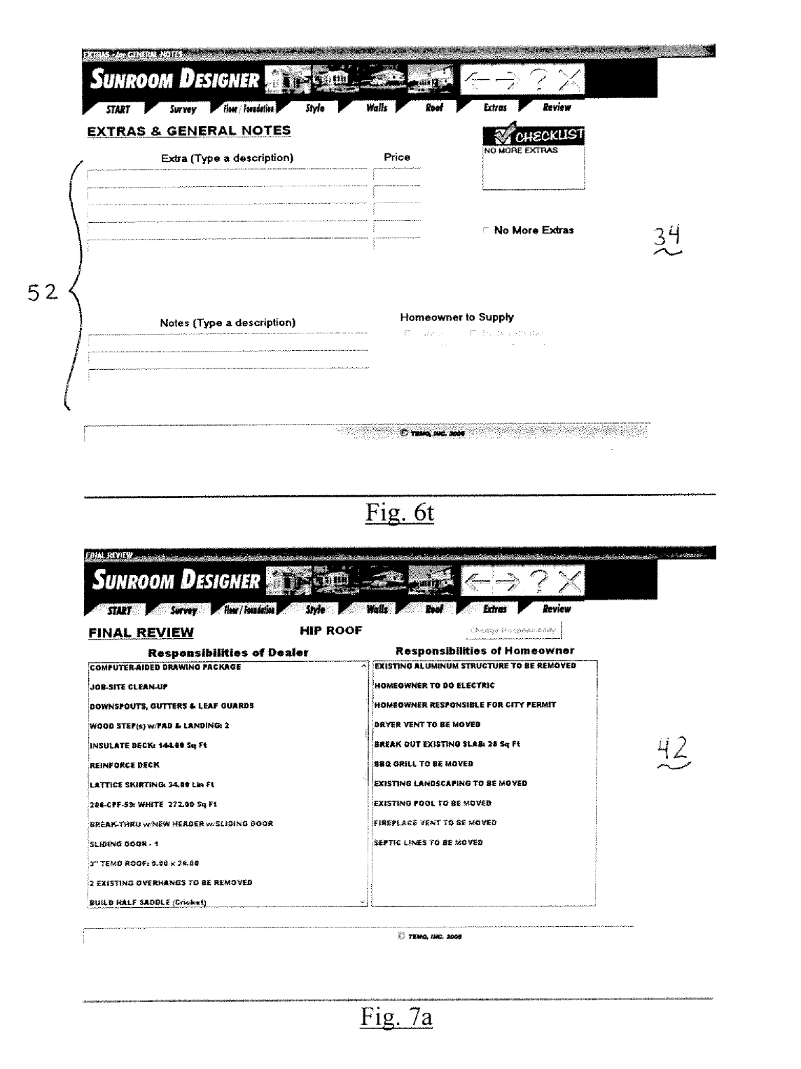

In one preferred configuration, the system includes three data entry fields comprising: i) customer or order information, ii) preexisting conditions of the surrounding building site, and iii) available components for the customized structure. As an example, referring to the drawings, FIG. 4 illustrates a screen depiction of a first data entry field, FIGS. 5a-f illustrates various screen depictions of a second data entry field, and FIGS. 6a-t illustrates various screen depictions of a third data entry field. As shown, each data entry field may be subdivided into subfields which may comprise subcomponents or screen depictions. For example, referring to FIGS. 5a-d, a first subfield to the second data entry field may comprise ‘MOVES & OBSTACLE’ to be performed prior to construction. Referring to FIGS. 5e-f, a second subfield to the second data entry field may comprise ‘EXISTING CONDITIONS’.

As previously mentioned, the software is configured progress through a series of inquiries 52 in which data entry points are provided for responding thereto. The software is configured to provide different inquiries and even different subfields based upon a response to a previous inquiry. Accordingly, a matrix is formed for traversing through a series of questions pertaining to the data entry fields. As such, depending upon the responses to the inquiries, it is contemplated that different inquiries and different subfields may be provided resulting in unique and customized building order. This concept is further illustrated herein, particularly with respect to the available design selection for the customized structure.

Checklist

In one preferred embodiment, the program is further configured with a check feature (such as check feature 36 shown in FIGS. 3a and 3b) to insure that all necessary data is entered (in response to the inquiries) prior to moving to a subsequent data entry section, subfield or even other inquiry. In doing so, this feature is configured to limit progression of the program based upon whether the user has completed all necessary sections of the current data entry section or otherwise. As such, it is contemplated that some or all of the data entry fields may include this feature. This is important as the program responds to the user and provides available design options, through the design matrix, based upon the input of the user. If the input is incomplete then the program may not be able to properly provide the user with appropriate design options or may not provide an accurate cost estimate of the job. However, this is not to say that it is required that every inquiry is responded to; but only those inquiries necessary.

For example, referring again to FIGS. 4-7h, this check feature is shown comprising a checklist 54 displaying all inquiry items 56, or at least all necessary inquiries, that have not yet been completed. As inquiries are responded to, the items are automatically removed from the checklist. Optionally, this feature may substantially prevent further progress of the program by preventing movement to a next data field, subfield or inquire, without fully completing the current inquire, e.g., removal of all listed inquire items. Also, an indicator may be provided, such as a message box, for providing an indication that all inquiries have not been responded to. The user is then prompted or otherwise provided the means to close the box and enter the missing data provided by the data.

Optionally, the checklist may not only remove inquiry items after they have been responded to, but may also add items based upon the responses to previous inquiries. For example, if the program has an initial inquiry regarding a certain condition of the proposed building site or regarding a design option, based upon the initial first inquiry, there may exist one or more additional inquiries to determine further potential conditions or make additional and more specific design choices. Also, in some situation, the program may make an additional inquiry on which party will be performing all or a portion of a specific task (e.g., removal, modification or otherwise) or a specific quantity or otherwise.

Customer Information

The software provides for the inputting of customer information in order to create a customer account. This allows one or more jobs or orders to be created and stored for subsequent modification, review or otherwise. Furthermore, this customer information may be placed on documents related to this customized order including any order, contractual agreement, or otherwise. For example, in one configuration, the first data entry field may include a plurality of data entry points to provide identification and contact information of a user including name, address, phone numbers, and e-mail addresses. Optionally, additional fields are provided for adding yet additional information such as sales representative, advertising and/or coupon source. Still further, the data field may further allow a user to search for previously creating jobs or customers. The information provided in these fields is saved to the hard disc or otherwise for subsequent retrieval.

It should be appreciated that the data entry field may include one or more subfields (not shown) for requesting additional information to a subcomponent or otherwise, or may include one or more screen displays for entering information, wherein each screen page inquires into further details for the specific field. These different screens may be accessed through the tool bar or tabs. However, the movement through the program may be limited by the program to insure that all of the items of the checklist have been completed.

Referring to FIGS. 3a and 4, a first input data field 30 is shown for entering information relating to a customer, job, user or otherwise. The data field allows a customer/user to enter identifying information for the customized job in response to the inquiries 52. In the configuration shown, the first data input field includes inquiries relating to names, address, telephone number, e-mail address, or otherwise or the user or customer. Optionally, the field may also be configured to enter information relating to the technical assistant or sales representative assisting the user in the formulating the design. Further, the field may be configured to enter information to an advertising source.

The information entered into the first field is saved to the computer for identification of the specific design job. Optionally, the information may be used or displayed throughout the customization to provide an indication of the customer or user. Also, this information will be used as identification of the design, order and any contract resulting therefrom, as described more fully herein.

The first field may also be configured to retrieve previous jobs. Previously initiated jobs are assigned a unique number or file name path, such as a telephone number, for identification. It should be appreciated that more than one job (e.g., 2, 3, or more) may be assigned to a specific telephone number. The field may include one or more windows for providing the ability to view and retrieve previously started jobs. In selecting these previously started or completed jobs, the system may be configured to bring the user to the portion of the design where the user had terminated the program and/or had otherwise saved. Alternatively, if the previous customization was complete, the system may provide the user with the completed design, order, or other related information. Still further, the first data entry field may be configured to search for previously started job by entering identification information (e.g., telephone number or otherwise).

Also, as previously mentioned, the first field may include program controls and a checklist to interact with the controls. As shown in the drawings, the checklist 52 includes a list of inquiry items 56 yet to be completed within the first data entry field. If the user attempt to move to another data entry field, the system may provide a message feature 36 (such as a message box) or other indicator informing the user to complete the data entry field.

Survey of Pre-Existing Conditions and Structures

The software is also configured for inputting information relating to the surrounding conditions to the building site of the structure so as to provide an accurate cost estimation, material list and allocated work to be performed. In doing so, the software includes a second data entry field 32 for entering this type of information. The information collected through the second data entry field is used to determine dimensions, styles, shapes, or otherwise of any resulting building structure that may be built.

It should be appreciated that the data entry field may include one or more subfields requesting more specific information relating to a condition, requirements, structure or otherwise. Also, the one or more subfields may include one or more screen displays for entering information, wherein each screen page inquires into further details for the specific field. These different screens may be accessed through the tool bar or tabs. However, the movement through the program may be limited by the program to insure that all of the items of the checklist have been completed.

In one configuration, the second data entry field includes a first subfield 46 for collecting information relating moves and obstacle that may or should be removed prior to construction of the structure. For example, referring to FIGS. 5a-d, this first subfield may include certain tasks inquiry to be performed including, without limitations thereto: i) removal of electric meters, ii) forming trenches including the length and depth thereof, iii) removal of existing structures include what material the structure is formed of, iv) removal of existing sump discharge pipe, v) forming of new or existing wall breakthroughs, vi) removal of siding, vii) removal of concrete or other slab, viii) removal of one or more railings, or otherwise. Upon selection of any of these required tasks, the customer or user is provided with additional inquiry to elect whether the customer or building will be performing the task.

Additionally, it is contemplated that certain task of the first subfield may be exclusively the responsibility of the customer. For example, referring to FIG. 5d, it is contemplated that items such as basement widows, barbeque grill, cable lines, existing landscaping, existing buildings (e.g. shed or otherwise), existing pool, existing trees, fireplace vent, phone lines, septic lines, sprinkler lines, or otherwise, may require movement or alteration by the customer or homeowner. Either, an indication whether one exists may be required to proceed with the program and to insure that this existing structure has been considered. Optionally, upon selection of the presence of an item to be removed, the item may change appearance (such as color) to provide a striking indication of responsibility to the customer. The first subfield may further include additional fields for inputting (via text or otherwise) additional tasks to be performed by either the customer or builder.

The second data entry field may also include a second subfield for collecting information relating to existing conditions of the surrounding environment. Such existing condition may be related to dimension of the existing conditions, such as dimensions of a building structure in which the custom structure is to be attached to, or otherwise.

It should be appreciated that the dimensions to be taken may be based upon the configuration or type of structure surrounding the customized building. For example, referring to FIG. 5e, when the customized structure is attached to a preexisting structure, it is contemplated that the second subfield may include one or more inquiries including type of home (e.g. single story, multi-level, multi-level with cantilever, or otherwise), amount of roof or other overhang to be remove, foundation of the preexisting structure (e.g. slab, crawl space, basement or otherwise), type of siding (e.g., frame, aluminum or vinyl, brick, rough stone, smooth stone, or otherwise), or otherwise. Based upon the selection of these or other features, an illustration corresponding to the selected components is formed for input of dimensions. This information provides the program with dimension that may be used to form at least a portion of the customized design.

For example, referring again to FIGS. 5e-f, in the application of customized sunroom designs, it is contemplated that the dimensions entered may relate to height or the grade to the enclosure floor at a front wall and at a wall adjacent or comprising the house. Other dimensions may include step down distance from the house to the enclosure floor, height from existing floor to the top portion of an existing door or window or roof overhang, the amount of roof overhang, or otherwise.

It should be appreciated that addition subfields may exist for inputting additional information relating to the surrounding environment. Also, the second field may include program controls and a checklist, as previously discussed, to interact with the controls.

Selection of Components

The software is further configured for inputting information relating to the selection of features used to form the customized structure. The selection of components and any resulting order may be based upon, at least in part, the information entered the second data entry field relating to the preexisting structure or environmental conditions. In doing so, the software includes a third data entry field 32 for entering this type of information. The information collected through the third data entry field is used to select components of the customized design. Examples of some available components include floor and/or foundation, style and/or size of structures, building material or color, structure layout (e.g. wall, window, door or otherwise), roof style, or otherwise. It should be appreciated that other design options are available.

In one configuration, as with the second data entry field, the third data entry field may include one or more subfields for collecting information pertaining to a group of items. For example, as illustrated in FIGS. 6a-6i, a first subfield to select the type of foundation to be used for the customized structure. Available options include whether a new or existing concrete slab or deck is to be used. Also, it is contemplated that additional data entry points are provided for providing yet additional features, in response to inquiries, for the floor and/or foundation such as slab surface (e.g. non-stamped or stamped finish), block type (e.g. standard, deco, or none), block wall height, whether a brick kneewall will be used, or otherwise. Based upon the selected floor or foundation style, it should be appreciated that more specific design selections can be made.

The third data entry field may also include a second subfield for selection of a style of structure to be formed. For example, referring to FIGS. 6j and 6k, a second subfield relating to styles of structures are shown including Studio, Cathedral, California, Solarium, Hip Roof, Lattice Roof Cover, Walls only, Patio Cover, or otherwise. Additional other features, such as wall colors, or otherwise, may also be selected.

Referring to FIG. 6l-6p, a third subfield may also be included for selection of a wall layout, based upon the selection of the second subfield and information entered in the second data entry field. The wall layouts can be based upon the existing walls of the structure, whether any partition walls will be included, whether any of the walls are angled, existing post, number of walls, or otherwise. Upon selection other information can be entered relating to the dimension of the walls, number of window, doors (e.g. sliding or wing), type of walls (e.g. 106-SL, 306-SPF-85, 206-SPF-59, 406-CCT-85, or otherwise), or otherwise. Optionally, based upon these selections, square footage of walls, room and roof liner can be generated. Still further, additional wall shapes can be selected include whether transoms will be used and where (e.g. top or bottom of walls), whether there will be any other specified shape including trapezoidal shaped walls. As should be appreciated numerous wall configurations can be generated.

Referring to FIG. 6r, a forth subfield includes roof selection and customization. This subfield provides a selection of roof projection and front width. Other options may include the number of full and half saddles to be used, whether it will comprise a wall or fascia mount roof. Further, the roof thickness and whether shingles (and what type) will be used. Still further, the user can select whether skylights will be installed and the number thereof.

A fifth subfield that may be used Include features to be installed or additional tasks to be performed. This may include features that do not necessarily comprise the basic structure of the addition or otherwise, but instead comprise aesthetic, comfort or safety features, or otherwise. For example, referring to FIG. 6s, the fifth subfield may include: obtaining a local building permit, the addition of an electrical package (e.g. outlets, porch lights and switches therefore), smoke alarms, track lighting, ceiling fans, hand rails (e.g. aluminum, wood, glass with aluminum, or otherwise), tiles (ceramic or otherwise) over the wood or concrete flooring, window treatments (e.g., blinds), wall finishing, the addition or upgrade of electric supply (e.g. 100, 200, or other amperage), spa and/or spa heater electrical connectors, furniture, color, doors (e.g. French or otherwise) and delivery thereof, boundary survey, mortgage survey, elevation certificate, or otherwise. As should be appreciated, numerous other customized features may be included and are within the scope of the invention. Also, it is contemplated that additional data entry points or fields, in response to inquiries, may be provided for the addition of features or other specifications or instructions for forming the structure.

It should be appreciated that additional subfields may exist for inputting additional information relating to the surrounding environment. Also, the second field may include program controls and a checklist, as previously discussed, to interact with the controls.

Order Review and Placement

Upon completion of the selection of components, the system generates a summary of order of the customized design for review by the user. This summary includes a section describing work and materials to be performed and/or supplied by the builder. Optionally, this summary may also include a section describing work and/or material to be performed and/or supplied by the customer. If the user wishes to make changes or notices an error during the review, the user can use the program controls, as described herein, to make changes to the order. Optionally, the details of the order may comprise or otherwise include a hyperlink, or the like, to move to that section of the program for review and alterations thereof. Also, the summary of order may also include the ability the change the responsibility of the task.

Optionally, upon completion of review of the customized order, an agreement or contract may be generated, which includes the customer information, building company information, and/or the customized order. The agreement may also include a price quote based upon the order and estimated monthly payments based upon selected interest rates. This agreement may then be saved and/or printed for the parties (e.g., customer and builder) to enter into.

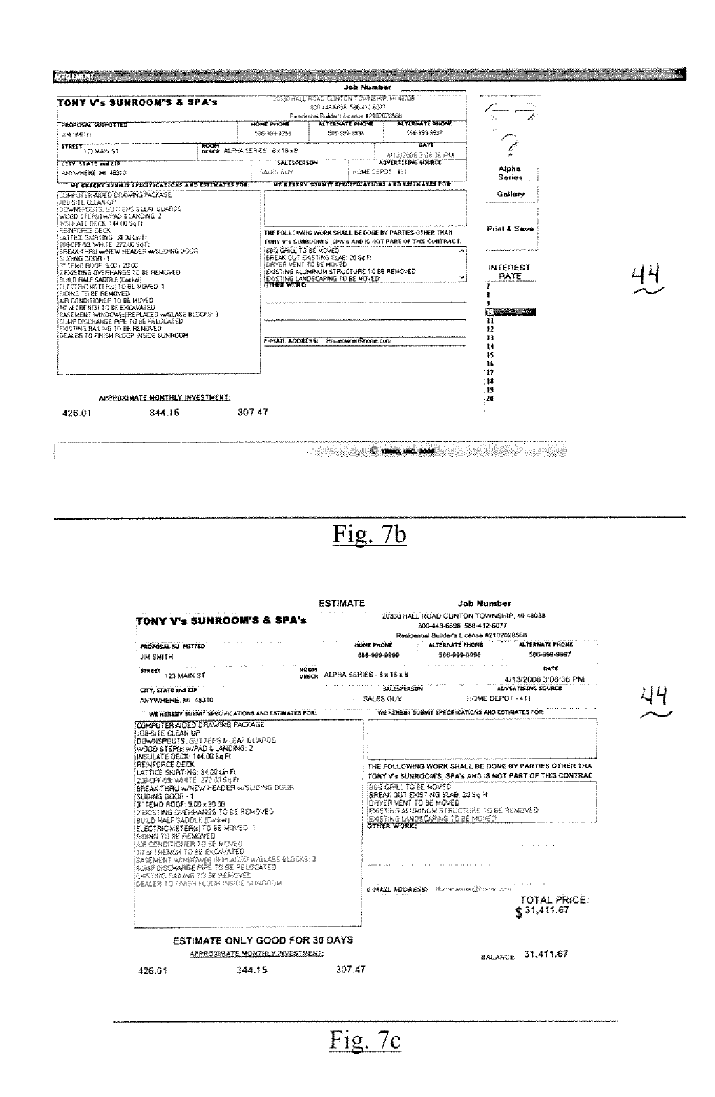

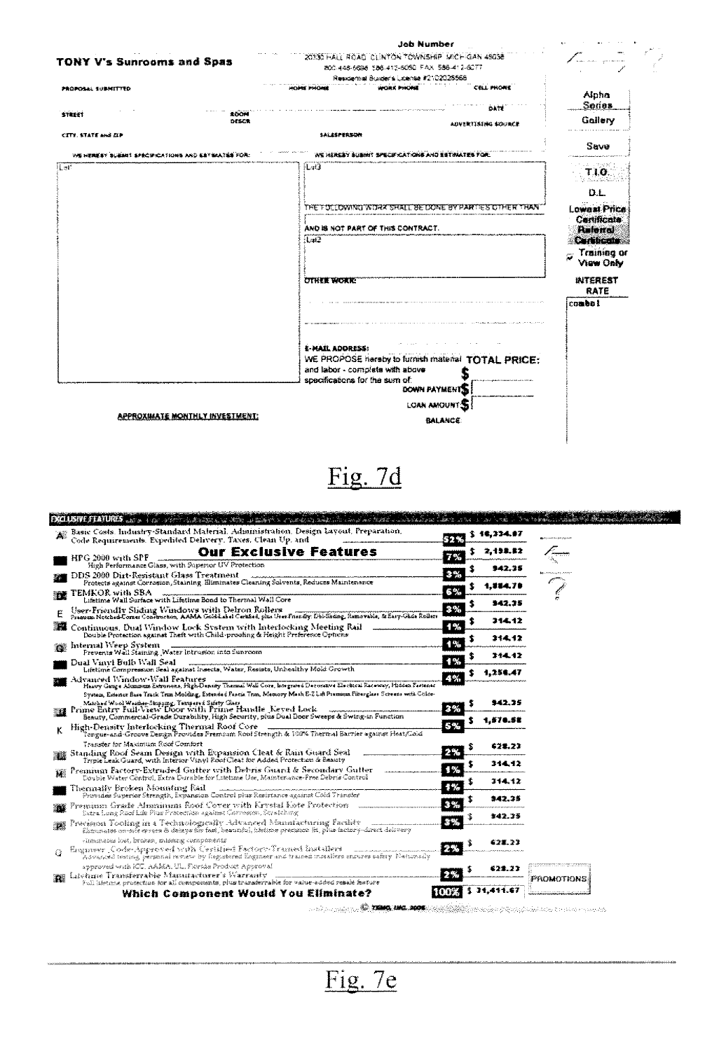

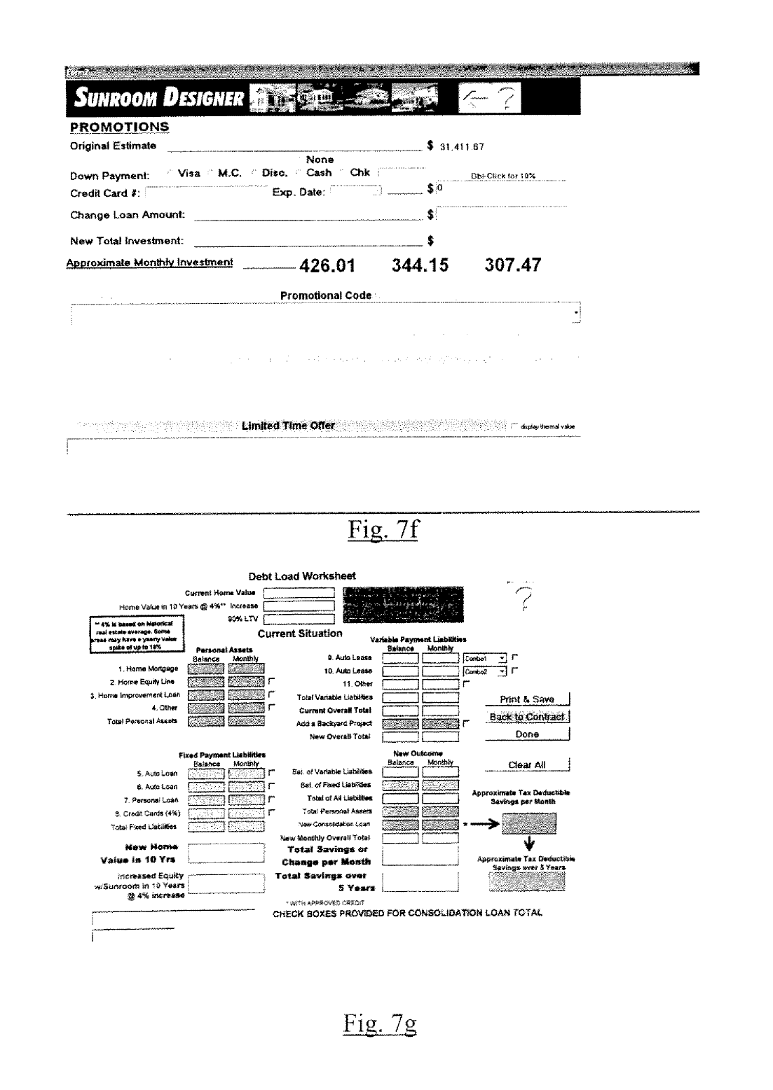

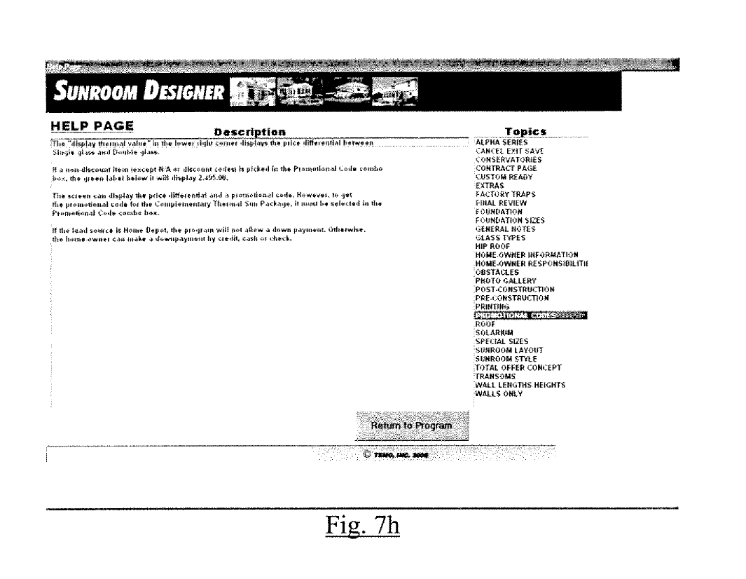

Referring to FIG. 7a, an example of a summary of order is shown. Upon review and acceptance of the order, the user proceeds to the following screens, shown in FIGS. 7b and 7c, to formalize the order and/or contract between the customer and the builder.

Purchasing Incentives

The present invention is also configured for providing a customized building structure within the income constraints of a customer or user. In doing so, the software provides the ability to easily traverse through the program to change the selection of different components or responsibilities in view of the resulting estimated cost. The software also provides for incentives, coupons or otherwise for reducing the overall cost of the building structure.

In a first feature, as previously described, the present invention allows a user to easily traverse through the program (e.g. through hyperlinks, tabs, scroll bar or otherwise) to change selected components, features or responsibilities of task to be performed. Upon selection, the user may receive additional inquiries based upon the changed inputted information. Accordingly, it is contemplated that the check list may provide assurance that all necessary information will be entered to formulated the amended design.

In a second feature, referring to FIGS. 7b and 7c, the system may provide monthly cost estimation for the customized structure. In doing so, the customer is afforded the ability to adjust monthly payments selecting three or more projected time periods (e.g., 5 years, 10 years, 15 years, 20 years, 25 years, or otherwise) to finance the structure. The user is allowed to select an interest rate which may be based upon the availability of credit to the customer or other upon predicted interest rates. Upon selection, different values are provided to show projected monthly payments for the customized structure, which is based upon the estimated cost or the structure.

In a third feature, referring to FIG. 7d, the system may provide an option to use prefabricated constructed structures to reduce the estimated cost of the structure. In doing so, the system may provide a link to the design selection of a prefabricated component. Thereafter, the user or customer is provided inquiries for customizing the prefabricated or substantially prefabricated structure. It should be appreciated that this prefabricated component may comprise some or all of the building structure. Optionally, the system may provide a link to the different photo or drawings renditions of the prefabricated components.

In a fourth feature, referring to FIGS. 7d and 7g, the system may provide a debt load worksheet (D.L.) for assisting the consumer to obtain financing for the building structure or otherwise for determining if the resulting design is affordable in view of the customer's financial situation. The work sheet may include data entry points for entering financial information such as personal assets, fixed payment liabilities, variable payment liabilities, or otherwise. The program then assess, the information to generate a financial position of the customer for purposes of obtaining a loan or otherwise. This may also include an indication of how the building structure may increase the value of any preexisting structure or property, over time, available tax deduction, and how much saving can be obtained.

In a fifth feature, referring again to FIGS. 7d and 7e, the system may provide a total investment option for reviewing a list components, along with associated cost, of the customized structure for possible changes thereto. Optionally, the listed components provide a link to traverse to that portion of design for changes thereto.

In a sixth feature, referring to FIGS. 7e and 7f, the system may provide promotions for reducing the cost of the customized structure. The promotions may be provided by the builder, which may be based upon the selected structure design or otherwise. Such promotions may be based upon the selection of certain design choices or packages (e.g. prefabrication or otherwise).

In a seventh feature, referring to FIGS. 7d and 7l, the system may include a lowest price certificate for guaranteeing that the customer could not attain the same quality of structure at the same price.

In an eighth feature, referring again to FIG. 7d, the system may provide a referral certificate for obtaining a reduction in cost of the customized structure based upon being referred by a previous customer or if a subsequent customer selects the builder based upon the current customer's recommendation.

It should be appreciated that the system may provide other features for providing the customized building structure based upon the user's financial position.

Example of Operation

As previously mentioned, the system of the present invention may be utilized for forming numerous types of building structures, or otherwise. Of these applications, one particularly advantageous application includes the use of the system to create a customized addition to a preexisting structure, such as a house. In one particularly advantageous application, the system is used to create a customized sunroom or conservatory for a home. The following described one method and process for forming a customized sunroof, conservatory or the like, and an order therefore, using the system of the present invention.

At the onset, the first software program of the present invention is installed on a computer having a typical user interface (e.g., monitor, keyboard, mouse or otherwise). The first software program comprises a design program for determining customer information, surrounding conditions to the proposed building structure, and selected components of the customized building structure. The first software may be provided by a manufacture of customized structure that is in the business in formulating building kits or substantially complete structures based upon the selected features of a customer. When the customer order is received, the manufacture prepares a kit or the complete building structure for installation by a builder.

Preferably, the computer belongs or is otherwise utilized by a sales representative of the builder and thus comprises a portable computer such as a laptop. Optionally, during installation or sometime thereafter, the builder provides information to the software pertaining to identification of the builder sufficient to establish a contract (e.g., business name, address, telephone number or otherwise). The software may be provided by a manufacture of sunrooms, conservatory or what ever the customized building structure may comprise. Optionally, upon installation, the software may be updated, via the Internet or otherwise, to insure availability to the most recent available design choices by the manufacture.

After installation of the first software, the second software is installed onto the laptop computer. The second software includes prices for material and work for the formulated customized structure. Preferably, the pricing rates of the second software are configured by the builder of structure, wherein the builder may provide a price based upon the skills, reputation, location or other characteristic of the builder. Optionally, the pricing software may be encrypted or password protected to insure that the pricing guidelines are followed in formulating the customized building order and cannot be changed by the user (e.g. sales representative, customer or otherwise).

With the software installed, the sales representative brings the system to the proposed building site (e.g. home) to formulate the customized structure based upon the selected components by the customer.

Upon initiation of the computer program, referring to FIG. 4, the system provides the first data entry field, as described herein, requesting information pertaining to the customer including name and contact information. This field also request information pertaining to the sale representative and any advertising source or discount the user may have. Alternatively, the user can search and/or select a previous initiated design. Upon completion of the first data entry field, the user clicks on the tab or more preferably click the arrow indicating the next screen page. If the user has failed to complete all of the items listed in the checklist box, a message box appear directing the user to complete all of the fields. Optionally, the program will prevent the user from progressing to the next page, stage or data entry field of the design prior to completing the missing information.

Upon completion of the first data entry field, Referring to FIGS. 5a-f, the system provides the second data entry field, as described herein, requesting information pertaining to the surrounding conditions and more particularly to the structure of the preexisting house and surrounding components thereto. For example, FIGS. 5a-d illustrates a first subfield of the second data entry field for entering information of the surrounding structure that may impede progression of construction. Not only does the program request this information, but also inquires on whether the builder or customer will be removing the impeding object.

Referring to FIGS. 5e and 5f, the program next inquires to the type of style of house including number of stories, overhang, founding and type of siding. With this information provided, the program then request information pertaining to dimension of the existing structure and more specifically the house. This information includes height from a ground surface to the floor portion of a proposed or existing floor. This information also include measurement from the proposed floor to the base of the entrance of the house, distance from the base to the upper most door opening and the distance from the base of the door opening to any roof overhang. As with the first data entry field, if the user has failed to complete all of the items listed in the checklist box, a message box appear directing the user to complete all of the fields and the program may prevent the user from progressing to the next page, stage or data entry field.

With the surrounding conditions of the home ascertained, the program provides the user with a third data entry field, as described herein, for selecting components of the sunroom, in view of the information provided in the second data entry field. Referring to FIG. 6a, the program provides a first subfield to request the foundation type for the sunroom (e.g. new or existing concrete slab or new or existing deck). Depending on the type of foundation selected, the program then provides additional inquiries determine features of the foundations and measurement thereof, see FIGS. 6b-i.

Referring to FIGS. 6j-p, the program then progresses to a second subfield for allowing the user to select a style of sunroom. As with the foundation, depending upon the selected style of sunroom, the program offers different options to customize the selected style. During this additional customization, the user is provided with the opportunity to select features such as windows, wall shape and size. However, if the user selects a size inconsistent with previously provided information, the program warns the user of potential problems. Referring to FIGS. 6q-t, upon completion, the user is further prompted to provide additional information relating to the foundation and roof of the sunroom. Optionally, in another subfield, the user is prompted to provide additional extra features to be included with the completed sunroom.

Again, as with the first and second data entry field, if the user has failed to complete all of the items listed in the checklist box, a message box appear directing the user to complete all of the fields and the program may prevent the user from progressing to the next page, stage or data entry field.

Based upon the information provided in the first, second and third data entry fields, the program provides the user with a final review of the customized design/order, shown in FIG. 7a. This final review describes material and responsibilities of work to be performed by the customer and builder. Upon confirmation, referring to FIG. 7b, the program optionally creates an agreement or contract including the details of the design and parties to be contracted.

Optionally, referring to FIG. 7c, the program may further provide options for reducing the overall cost of the sunroom or building structure, as described herein. Also, as shown in FIG. 7d, the program may also provide for payment options (including credit card, cash or check) and input of promotion codes for reducing the cost of materials, labor cost, or both, as described herein.

Referring to FIG. 7e, the program is further configured to provide a help menu for assisting the user in any of the forgoing data entry fields or otherwise.

In view of the foregoing, the present invention provides a system, method and software application for creating a customized building structure, such as a sunroom, based upon the input of existing surrounding conditions. The present invention also includes one or more features for insuring complete input of information to insure complete and accurate design and validation feature for warning user of atypical dimensions or selections. Furthermore, upon completion of the customized design the present invention provide a customized order, with cost estimation, and optionally a contract formed between the customer and builder for building the customized sunroom.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

What is claimed is:

1. A design system for creating customized building structures, the system including:
a computer having a user interface for allowing a user to interact with a software program for creating a customized building order, the software program providing:
a first data entry field for inputting and storing information relating to a customer or job;
a second data entry field for inputting and storing information relating to preexisting conditions surrounding a building site for the customized building order;
a third data entry field for selecting and storing information relating to the customized building addition based at least in part upon the information inputted in the second data entry field; and
an output comprising an order for the customized building addition which is based upon the information entered in the first, second and third data entry fields.

2. The design system of claim 1, wherein the first data entry field is configured for receiving information relating to a customer's name, address, telephone number, e-mail address or combinations thereof.

3. The design system of claim 2, wherein the second data entry field is configured for receiving information relating to the presence of one or more preexisting structures.

4. The design system of claim 3, wherein the second data entry field is configured for receiving information relating to style, dimensions or both of at least one of the one or more preexisting structures.

5. The design system of claim 4, wherein the second data entry field is configured for receiving an indication of removal or alteration of at least one of the one or more preexisting structure and of a specified party that will be removing or altering the preexisting structure.

6. The design system of claim 1, wherein any of the first, second or third data at entry fields includes one or more checklists including a list of items that must be completed prior to movement to another data entry field or a subfield thereof.

7. The design system of claim 1, wherein the third data entry field is configured for allowing a user to select features to form the customized building addition.

8. The design system of claim 7, wherein at least one of the features includes the selection of a foundation type for the customized building structure.

9. The design system of claim 8, wherein at least one of the features include the selection of a sunroom or conservatory style.

10. The design system of claim 9, wherein at least one of the features includes the selection of a wall configuration for the selected building addition style.

11. The design system of claim 1, wherein the output includes an overview of the customized building addition.

12. The design system of claim 11 wherein the output includes cost estimation for the customized building addition.

13. The design system of claim 1, wherein the customized building structure comprises a sunroom or conservatory.

14. A design system for creating customized sunroom or conservatory for a preexisting home, the system including:
a computer having a user interface for allowing a user to interact with a software program for creating and storing information relating to a customized sunroom or conservatory order, the software program providing:
a first data entry field for inputting and storing information relating to a customer or job, a second data entry field for inputting and storing information relating to preexisting conditions surrounding a building site for the customized sunroom or conservatory, and a third data entry field for selecting and storing information relating to the customized sunroom or conservatory based upon the information inputted in the second data entry field;
a check feature for insuring that all information in the first, second and third data entry fields necessary for forming the customized sunroom or conservatory are entered;
an output comprising an order for the customized sunroom or conservatory which is based upon the information entered in the first, second and third data entry fields.

15. The design system of claim 14, wherein the software program further comprises a validation feature for insuring that data entered is consistant based upon previously entered data.

16. The design system of claim 14, wherein the software program further provides a contract for the building of the customized sunroom or conservatory order based upon the information entered in the first, second and third data entry fields.

17. The design system of claim 14, wherein the software program further provides one or more additional data entry fields for modifying the order, entering financial information of the customer for determine credit eligibility, or entering discount information for reducing the cost of the customized sunroom or conservatory order.

18. A method of formulating a customized order for a sunroom or conservatory, the method including the steps of:
providing a computer at a proposed building site the computer having a user interface, and software configured for providing data entry fields for entering information for forming a customized sunroom or conservatory at the proposed building site;
inputting information in a first data entry field provided by the software, the first data entry field configured for receiving information related to a user or customer;
inputting information in a second data entry field provided by the software, the second data entry field configured for receiving information related to preexisting conditions of a home to which the sunroom or conservatory is to be attached;
inputting information in a third data entry field provided by the software, the third data entry field configured for receiving information related to selected components for the customized sunroom or conservatory; and
generating a customized order for the sunroom or conservatory.

19. The method of claim 18, further comprising the step of providing a contract between the user or customer and a builder based upon the generated order.

20. The method of claim 19, further comprising the step of providing one or more additional data entry fields for modifying the order, entering financial information of the customer for determine credit eligibility, or entering discount information for reducing the cost of the customized sunroom or conservatory order.
